(19) United States
(12) Patent Application Publication
(10) Pub. No.: US 2005/0007971 A1
(43) Pub. Date: Jan. 13, 2005

(54) Method for transmitting an MBMS control message in a mobile communication system

(75) Inventors: Kyeong-In Jeong, Suwon-al (KR); Sung-Ho Choi, Suwon-al (KR); Kook-Heul Lee, Yongin-si (KR); Soeng-Hun Kim, Suwon-al (KR); Eun-Jung Kim, Suwon-al (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/841,052

(22) Filed: May 7, 2004

(30) Foreign Application Priority Data
May 10, 2003 (KR) 2003-29657

(51) Int. Cl. H04H 1/00

(52) U.S. Cl. 370/312

(57) ABSTRACT

A method for dividing MBMS control information provided to UEs for an MBMS service into three types and separately transmitting the divided MBMS control information according to their types. The MBMS control information is divided into first MBMS control information that is periodically transmitted, and second MBMS control information that is aperiodically transmitted due to occurrence of an event. The periodically transmitted first MBMS control information is divided into MBMS control information that is transmitted at a first periodic interval and MBMS control information that is transmitted at a second periodic interval. The first periodic interval is shorter than the second periodic interval to enable a UE desiring to receive a particular MBMS service to preferentially receive MBMS status information in advance of MBMS RB information.

### PRIORITY

This application claims priority under 35 U.S.C. § 119 to an application entitled “Method for Transmitting MBMS Control Message in a Mobile Communication System” filed in the Korean Intellectual Property Office on May 10, 2003 and assigned Serial No. 2003-29657, the contents of which are incorporated herein by reference.

### BACKGROUND OF THE INVENTION

1. Field of the Invention

The present invention relates generally to a method for providing a Multimedia Broadcast/Multicast Service (MBMS) in a mobile communication system, and in particular, to a method for transmitting MBMS control information.

2. Description of the Related Art

Currently, due to the development of communication industry, a Code Division Multiple Access (CDMA) mobile communication system is evolving into a mobile communication system supporting multicasting multimedia communication for transmitting voice service data as well as mass data, such as packet data and circuit data. In order to support the multicasting multimedia communication, a Broadcast/Multicast Service for transmitting the same data from one data source to a plurality of user equipments (UEs) must be provided.

The Broadcast/Multicast Service can be classified into a Cell Broadcast Service (CBS), which is a message-oriented service, and a Multimedia Broadcast/Multicast Service (MBMS) for supporting multimedia data such as real-time image and voice, still image, and text.

The CBS service refers to a service for broadcasting multiple messages to all UEs located in a particular service area. Here, the particular service area can be the overall area where the CBS service is provided, i.e., within one cell.

The MBMS service refers to a service for transmitting the same multimedia data to a plurality of UEs via a radio network. The MBMS service requires mass transmission resources because it simultaneously provides voice data and image data. The MBMS service provided over a broadcast channel in view of the possibility that many services will be simultaneously provided in the same cell. Therefore, UEs receiving the same MBMS service from the same Node B can save radio resources by sharing one radio channel.

FIG. 1 is a diagram illustrating a configuration of a conventional mobile communication network for an MBMS service. In FIG. 1, an MBMS service is applied to a 3GPP asynchronous mobile communication system.

Referring to FIG. 1, a description will now be made of fundamental entities for providing an MBMS service and relations between the entities in a mobile communication system.

In FIG. 1, UEs 101, 102, 103, 104, 105, 106, 107, and 108 are terminal devices capable of receiving an MBMS service. A first cell (Cell#1) 111, a second cell (Cell#2) 112, and a third cell (Cell#3) 113 are service areas divided by Node B 121. The UEs 101, 102, 103, 104, 105, 106, 107, and 108 are located in any one of cell areas of the cells 111, 112, and 113. The Node B 121 transmits MBMS data for the MBMS service to the UEs 101, 102, 103, 104, 105, 106, 107, and 108. In this case, only one radio channel for the MBMS service is established between the Node B 121 and the UEs 101, 102, 103, 104, 105, 106, 107, and 108. A radio network controller (RNC) 131 controls a plurality of Node Bs. Here, the RNC 131 selectively transmits the MBMS data to a particular Node B 121 among the plurality of the Node Bs, and controls a radio channel set up to provide the MBMS service. The radio channel refers to a radio channel set up between the Node B 121 and the UEs 101, 102, 103, 104, 105, 106, 107, and 108 for the MBMS service.

A UMTS (Universal Mobile Telecommunications System) radio access network (UTRAN) comprises the RNC 131, the Node B 121 controlled by the RNC 131, and the first to third cells 111, 112, and 113. The UTRAN connects the UEs 101, 102, 103, 104, 105, 106, 107, and 108 to a core network (CN).

A serving GPRS (General Packet Radio Service) support node (SGSN) 141 performs MBMS service-related control on each of the UEs 101, 102, 103, 104, 105, 106, 107, and 108. For example, the SGSN 141 manages MBMS service accounting-related data for each of the UEs 101, 102, 103, 104, 105, 106, 107, and 108, and selectively transmits MBMS data to a particular RNC. A home location register (HLR) 151 is connected to the SGSN 141 and authenticates each of the UEs 101, 102, 103, 104, 105, 106, 107, and 108.

A gateway GPRS support node (GGSN) 161 delivers MBMS data to be provided to the UEs 101, 102, 103, 104, 105, 106, 107, and 108, to the SGSN 141. The MBMS data is provided from a contents provider 191 to the GGSN 161 via a broadcast/multicast service center (BM-SC) 181, or provided from multicast/broadcast sources 192 and 193 to the GGSN 161 via a border gateway (BG) 171. Further, the GGSN 161 manages a moving situation of each of the UE 101, 102, 103, 104, 105, 106, 107, and 108, and manages quality of service (QoS) for an MBMS service provided to the UE 101, 102, 103, 104, 105, 106, 107, and 108.

The BG 171 receives MBMS data from the multicast/broadcast sources 192 and 193 existing in a network that is not managed by the current service provider, and delivers the received MBMS data to the GGSN 161. The BM-SC 181 receives MBMS data from the contents provider 191 and delivers the received MBMS data to the GGSN 161. Further, the BM-SC 181 authenticates the contents provider 191, determines a QoS of an MBMS service, performs error correction on defective MBMS data, provides accounting information to the contents provider 191, and notifies the UEs of a current MBMS service. The contents provider 191 and the multicast/broadcast sources 192 and 193 serve as a source for providing MBMS data.

In the configuration described above, MBMS data provided from the contents provider 191 is delivered to the GGSN 161 via the BM-SC 181, and MBMS data provided from the multicast/broadcast sources 192 and 193 is delivered to the GGSN 161 via the BG 171. Alternatively, the MBMS data provided from the multicast/broadcast sources 192 and 193 can be directly delivered to the GGSN 161 without passing through the BG 171. The GGSN 161 provides the received MBMS data to the SGSN 141, and the SGSN 141 delivers the MBMS data to the RNC 131.

The RNC 131 to which the MBMS data is delivered is restricted to a particular RNC that has received a corresponding MBMS service request. The RNC 131 delivers the MBMS data to the Node B 121. The Node B 121 to which the MBMS data is delivered is restricted to a particular Node B that has received a corresponding MBMS service request. The Node B 121 provides the MBMS data to the UEs 101, 102, 103, 104, 105, 106, 107, and 108 that have sent the corresponding MBMS service request, via the first to third cells 111, 112, and 113.

In the configuration illustrated in FIG. 1, for one MBMS service, one RNC is connected to one SGSN, and one Node B is connected to the RNC, by way example. However, multiple RNCs can be connected to each of multiple SGSNs and multiple Node Bs can be connected to each of the RNCs. In this configuration, one SGSN can selectively transmit MBMS data to a plurality of RNCs, and one RNC can selectively transmit MBMS data to a plurality of Node Bs. Accordingly, the SGSNs and the RNCs must manage a list of nodes to which they should deliver the MBMS data. For example, each of the SGSNs manages a list of RNCs to which it will deliver the MBMS data, and each of the RNCs manages a list of Node Bs to which it will deliver the MBMS data.

FIG. 2 is a diagram illustrating a conventional procedure performed between a UE 201, an RNC 211, and an SGSN 221, for providing an MBMS service. Although it is assumed in FIG. 2 that only one RNC is connected to an SGSN and only one UE is connected to the RNC, the number of RNCs and UEs is variable.

Referring to FIG. 2, in Announcement step 231, fundamental information on a particular MBMS service is delivered from the SGSN 221 to the UE 201. The fundamental information can include an identifier (ID) of the MBMS service and availability of the MBMS service. If there is a desired MBMS service among the MBMS services announced in the Announcement step 231, Joining step 241 is performed at the request of the UE 201. The Joining step 241 includes a process in which the UE 201 sends a request for a desired MBMS service to the SGSN 221 and a process in which the SGSN 221 performs an authentication procedure in response to the request from the UE 201 and then notifies the UE 201 of availability of the MBMS service. The SGSN 221 stores a list and positions of UEs desiring to receive a particular MBMS service through the Joining step 241.

If a notification of a start of the MBMS service is received from a BM-SC, in step 251, the SGSN 221 transmits a Session Start message to the RNC 211 based on the UE list stored through the Joining step 241. The Session Start message indicates that the desired MBMS service will be started shortly.

Upon receiving the Session Start message, in step 252, the RNC 211 transmits a Notification message in order to page the UE 201 intending to receive the MBMS service. Because a plurality of UEs can be paged by the Notification message, the step 252 is also called “group paging”, which is distinguishable from the exiting paging procedure. UEs paged by the group paging transmit a Notification Response message to the Notification message in step 262. Through the Notification Message transmission procedure, the RNC 211 can detect the number of UEs desiring to receive the corresponding MBMS service for each cell, and determine a type of a radio channel for the corresponding cell.

For example, if the number of UEs desiring to receive the corresponding MBMS service is larger than a predetermined threshold, the RNC 211 determines the type of the radio channel as a common channel. However, if the number of UEs desiring to receive the corresponding MBMS service is smaller than the predetermined threshold, the RNC 211 determines the type of the radio channel as a dedicated channel. When the type of the radio channel is determined as a common channel, a point-to-multipoint (PtM) mode is set, and when the type of the radio channel is determined as a dedicated channel, a point-to-point (PtP) mode is set. In the PtM mode, the RNC 211 assigns one common channel and transmits MBMS data over the common channel. In the PtP mode, the RNC 211 individually assigns dedicated channels to UEs requesting a particular MBMS service, and transmits MBMS data over the dedicated channels.

In step 271, the RNC 211 transmits radio bearer information (hereinafter referred to as “MBMS RB information”) to the UE 201 to which it will provide the corresponding MBMS service. The MBMS RB information is information on a radio channel over which an MBMS service will be provided, and can include orthogonal variable spreading factor (OVSF) code information, transport format information, radio link control (RLC) information, and packet data convergence control (PDCP) information. In step 281, an MBMS service between the UE 201 and the SGSN 221 is performed based on the MBMS RB information.

As described above, for an MBMS service, not only MBMS data but also a control signal for controlling the MBMS service must be multicasted to all UEs desiring to receive the MBMS service. For example, when the RNC 211 intends to provide a particular MBMS service in a particular cell, the MBMS RB information is available for all UEs requesting the particular MBMS service in the particular cell. Therefore, it is efficient that an MBMS control signal related to the MBMS service should be transmitted over a common control channel established in the cell.

In the 3GPP, which is currently managing standardization of the MBMS service, a method for defining a new logical channel called an MBMS control channel (MCCH) and transmitting an MBMS control signal over the MCCH is being studied. Also, a method for periodically transmitting the MBMS control signal is being studied. However, detailed methods thereof and detailed operations of the RNC and the UE have not specified yet.

FIG. 3 is a diagram illustrating a possible method for periodically transmitting MBMS control information. It is assumed in FIG. 3 that MBMS control information is periodically transmitted over MCCH and MBMS control information is transmitted to a plurality of UEs located in one cell.

Referring to FIG. 3, an RNC 311 transmits MBMS control information for a particular MBMS service over MCCH in steps 321, 322, and 323. The MBMS control information transmitted from the RNC 311 is uniquely defined for each cell. Therefore, unique MBMS control information can be transmitted to each cell. The reason for periodically transmitting MBMS control information in this way is to secure continuity of a particular MBMS service when a new UE 302 has moved to a current cell. UEs requesting the particular MBMS service receive the MBMS control information that is periodically transmitted from the RNC 311, thereby receiving a desired MBMS service.

Reference numeral 331 denotes a case where the UE 302 that was receiving a particular MBMS service in another cell has moved to the current cell. In step 322, the UE 302 cannot detect MBMS control information in the current cell to which it has entered until it receives MBMS control information. Based on the received MBMS control information, the UE 302 analyzes a mode in which a particular MBMS service is provided in the current cell. As described above, the mode where a particular MBMS service is provided is classified into a PtP mode and a PtM mode.

After receiving the MBMS control information and analyzing the mode where the MBMS service is provided, the UE 302 transmits an MBMS Service Request message to receive the MBMS service. If the MBMS service is provided in the PtP mode where assignment of a dedicated channel is needed, the UE 302 transmits an RRC Connection Request message for requesting setup of radio resource control (RRC) connection. The RRC Connection Request message includes an MBMS service ID for identifying the MBMS service.

In order for a UE that has newly entered a particular cell that uses the PtP mode to receive a particular MBMS service, the UE has a time delay corresponding to the sum of (i) a waiting time from an entering time (indicated by reference numeral 331) to a reception time (indicated by reference numeral 332) of MBMS control information, (ii) an MBMS service request time, and (iii) a PtP channel prepare time. It is known that as a transmission period of the MBMS control information is longer, the time delay is increased. Therefore, the increase in transmission period of the MBMS control information negatively affects continuity of the MBMS service, causing inconvenience to a user receiving the MBMS service.

Reference numeral 341 denotes a situation in which an event for an MBMS service happens. The event includes MBMS Notification, Channel type switching, RB reconfiguration, MBMS UE counting, etc. If such an event occurs, the RNC 311 must transmit, to the UEs, MBMS control information that is newly generated or modified due to occurrence of the event. However, the RNC 311 cannot transmit the newly generated or modified MBMS control information until it arrives at a period where MCCH can be transmitted. As a result, a time delay occurs between a time where the event occurs and a time where MBMS control information corresponding to occurrence of the event is transmitted. Sometimes, the delay may cause a fatal misoperation.

For example, assuming that an event for counting the number of UEs having an RRC connection for an MBMS service has happened at a point indicated by reference numeral 341, the RNC 311 transmits MBMS control information indicating occurrence of the counting event over a MCCH in step 322. In this case, a specific time delay occurs between a point 341 where the counting event happens and a point 322 where corresponding MBMS control information is transmitted. Then UEs in an idle mode, receiving the MBMS control information, analyze the MBMS control information and detect an occurrence of the counting event.

Among the UEs in an idle mode that have detected the counting event, UEs requesting a corresponding MBMS service attempt to establish an RRC connection to the RNC 311. In response, the RNC 311 sets up the RRC connection to the UEs and continuously counts the number of UEs to which the RRC connection is set up. The RNC 311 switches its MBMS transmission mode to a PtM mode if the number of UEs having the RRC connection and receiving the MBMS service is larger than a predetermined threshold. If the MBMS transmission mode is switched to the PtM mode, the RNC 311 transmits MBMS control information for instructing UEs not to attempt the RRC connection any longer, over the MCCH in step 323.

The UEs receiving the MBMS control information no longer attempt the RRC connection. However, because the MBMS control information can be transmitted in step 323, although the RNC 311 already determined to switch the MBMS transmission mode to the PtM mode through the counting, the RRC connection attempt by the UEs in the idle mode will continue until step 323. The RRC connection unnecessarily attempted by the UEs in the idle mode causes signaling overhead and signal congestion.

### SUMMARY OF THE INVENTION

It is, therefore, an object of the present invention to provide a method for efficiently transmitting an MBMS control message for an MBMS service in a mobile communication system.

It is another object of the present invention to provide a method for transmitting an MBMS control message to efficiently support mobility of a UE receiving an MBMS service.

It is further another object of the present invention to provide a method for allowing a UE desiring to receive an MBMS service to receive an MBMS control message with minimal time delay.

It is yet another object of the present invention to provide a method for separately transmitting an MBMS control message for an MBMS service at its unique transmission time.

It is still another object of the present invention to provide a method for transmitting an MBMS control message for an MBMS service using both periodic transmission and aperiodic transmission.

It is still another object of the present invention to provide a method for receiving by a UE an MBMS control message for an MBMS service in the form of a predetermined message type.

It is still another object of the present invention to provide a method for aperiodically transmitting an MBMS control message for an MBMS service when an aperiodically transmitted MBMS control message and an MBMS event happen.

It is still another object of the present invention to provide a method for newly defining and classifying an MBMS control message between a radio network controller and a UE according to its characteristic.

It is still another object of the present invention to provide a method for defining an MBMS status message including an MBMS service ID and MBMS transmission mode select information, and periodically transmitting the MBMS status message over MCCH using a period shorter than that of an MBMS RB message.

It is still another object of the present invention to provide a method for reducing a time delay to secure continuity of an MBMS service by reducing a waiting time in receiving an MBMS service by a UE that has entered a new cell.

It is still another object of the present invention to provide a method for periodically transmitting an MBMS RB message using a period longer than that of an MBMS status message.

It is still another object of the present invention to provide a method for newly defining an MBMS control message that aperiodically transmits MBMS control information corresponding to an MBMS event for an MBMS service when the MBMS event occurs, and immediately transmitting the MBMS control message when the MBMS event occurs.

In accordance with a first aspect of the present invention, there is provided a method for transmitting by a radio network controller (RNC) a control message for a Multimedia Broadcast/Multicast Service (MBMS) to each cell in a mobile communication system including the RNC, a plurality of Node Bs, each of the Node Bs being connected to the RNC and controlling at least one cell, and a plurality of user equipments (UEs) located in each cell. The method comprises the steps of: transmitting a first control message for the MBMS service by a predetermined period; and transmitting a second control message caused by occurrence of an event being involved in control on the MBMS service, at an occurrence time of the event. The event irregularly occurs at a particular time where the first control message is transmitted.

In accordance with a second aspect of the present invention, there is provided a method for transmitting by a radio network controller (RNC) a control message for a Multimedia Broadcast/Multicast Service (MBMS) to each cell in a mobile communication system including the RNC, a plurality of Node Bs, each of the Node Bs being connected to the RNC and controlling at least one cell, and a plurality of user equipments (UEs) located in each cell. The method comprises the steps of: transmitting a status information message that the UE should preferentially receive to receive the MBMS service among control messages for the MBMS service, by a first period; and transmitting a radio bearer (RB) information message among the control messages for the MBMS service by a second period which is relatively longer than the first period.

In accordance with a third aspect of the present invention, there is provided a method for receiving by a user equipment (UE) a control message for a Multimedia Broadcast/Multicast Service (MBMS) from a radio network controller (RNC) in a mobile communication system including the RNC, a plurality of Node Bs, each of the Node Bs being connected to the RNC and controlling at least one cell, and a plurality of user equipments (UEs) located in each cell. The method comprises the steps of: receiving a first control message for the MBMS service that is transmitted by a predetermined period; and receiving a second control message that is aperiodically transmitted due to occurrence of an event being involved in control on the MBMS service. The second control message is received at a particular time where the first control message is received due to irregular occurrence of the event.

In accordance with a third aspect of the present invention, there is provided a method for receiving by a user equipment (UE) a control message for a Multimedia Broadcast/Multicast Service (MBMS) from a radio network controller (RNC) in a mobile communication system including the RNC, a plurality of Node Bs, each of the Node Bs being connected to the RNC and controlling at least one cell, and a plurality of user equipments (UEs) located in each cell. The method comprises the steps of: receiving a status information message that the UE should preferentially receive to receive the MBMS service among control messages for the MBMS service, by a first period; and receiving a radio bearer (RB) information message among the control messages for the MBMS service, by a second period which is relatively longer than the first period.

### BRIEF DESCRIPTION OF THE DRAWINGS

The above and other objects, features, and advantages of the present invention will become more apparent from the following detailed description when taken in conjunction with the accompanying drawings in which:

FIG. 1 is a diagram illustrating a configuration of a conventional mobile communication network for an MBMS service;

FIG. 2 is a diagram illustrating a conventional procedure performed for providing an MBMS service;

FIG. 3 is a diagram illustrating a conventional method for periodically transmitting MBMS control information;

FIG. 4 is a diagram illustrating a procedure for separately transmitting subdivided MBMS control information at different times according to an embodiment of the present invention;

FIG. 5 is a flowchart illustrating an operation of an RNC according to an embodiment of the present invention;

FIG. 6 is a flowchart illustrating an operation of a UE according to an embodiment of the present invention; and

FIGS. 7A and 7B are flowcharts illustrating a cell reselection procedure performed by a UE according to an embodiment of the present invention.

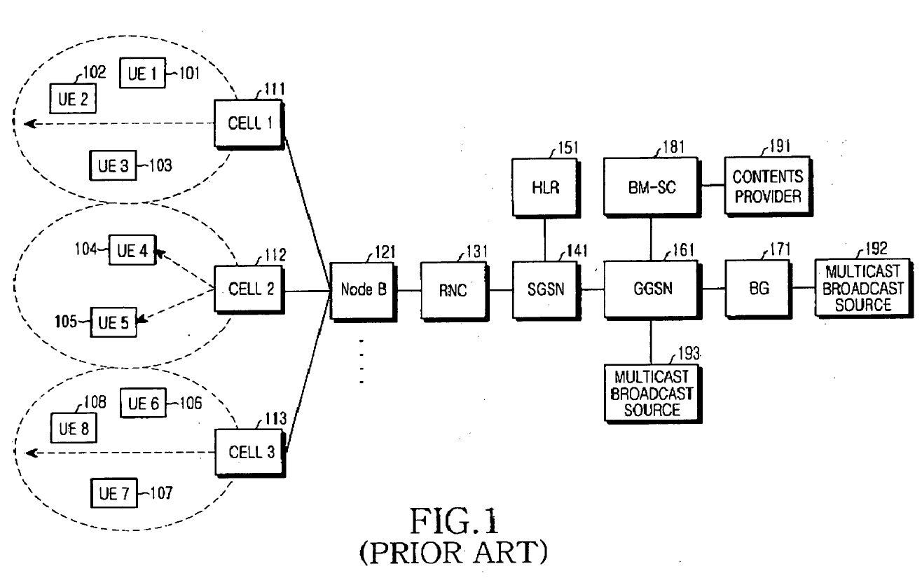

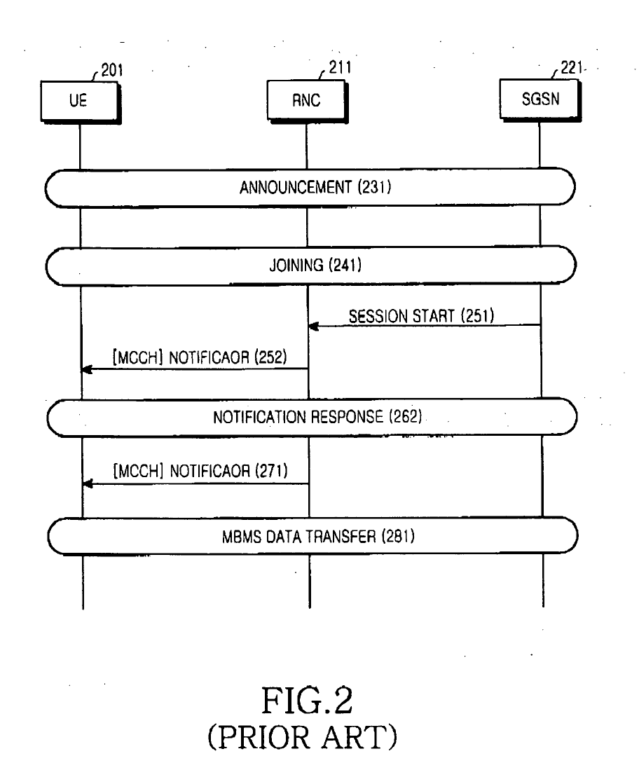

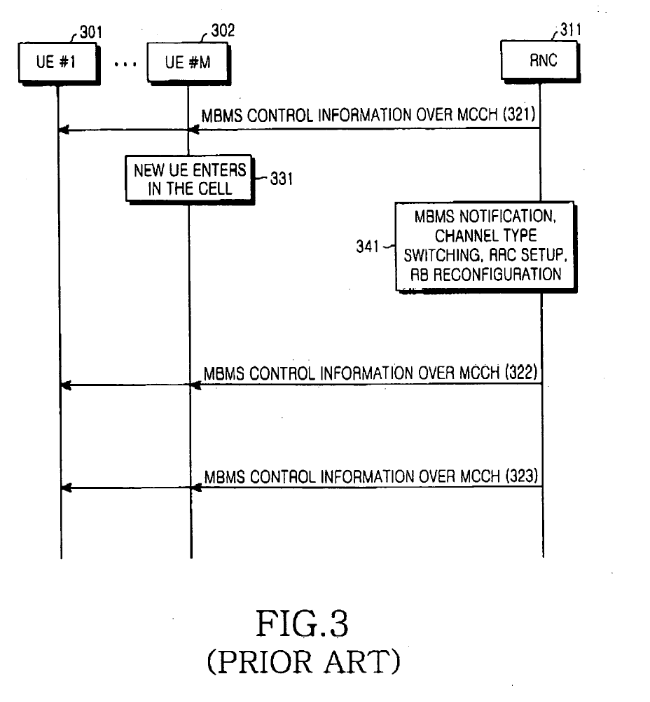

### DETAILED DESCRIPTION OF THE PREFERRED EMBODIMENT

Preferred embodiments of the present invention will now be described in detail herein below with reference to the annexed drawings. In the following description, a detailed description of known functions and configurations incorporated herein has been omitted for conciseness.

The present invention proposes a method for dividing MBMS control information provided to UEs for an MBMS service into three different types and separately transmitting the MBMS control information according to the types. That is, in the present invention, MBMS control information is divided into first MBMS control information that is periodically transmitted, and second MBMS control information (hereinafter referred to as “MBMS event information”) that is aperiodically (or asynchronously) transmitted each time an irregular event happens. The aperiodic (or asynchronous) transmission of the MBMS event information is caused as the event happens irregularly.

The aperiodically transmitted first MBMS control information is divided into MBMS control information (hereinafter referred to as “MBMS status information”) transmitted by a first period and MBMS control information (hereinafter referred to as “MBMS RB information”) transmitted by a second period. The first period is relatively shorter than the second period. This enables a UE requesting a particular MBMS service to receive the MBMS status information in advance of the MBMS RB information.

The MBMS status information includes MBMS control information that must be received in advance in order for a UE to receive an MBMS service based on the MBMS RB information that is to be received later. For example, the MBMS status information includes an MBMS service ID and MBMS transmission mode information. The MBMS transmission mode information is information used for selecting a PtP mode or a PtM mode. The MBMS status information is transmitted as an MBMS status information message. The MBMS RB information that is transmitted using a longer period than that of the MBMS status information is information on a radio channel over which an MBMS service is to be provided. The MBMS RB information includes OVSF code information, transport format information, RLC information, and PDCP information. The MBMS RB information is transmitted as an MBMS RB information message. The MBMS event information is transmitted over an MCCH at the time where a particular event happens in an RNC. This enables a UE desiring to receive a particular MBMS service to rapidly detect occurrence of a particular event. The MBMS event information includes an MBMS service ID and an MBMS cause value. The MBMS cause value can include MBMS Notification, Channel type switching, RB reconfiguration, and MBMS UE contenting. The MBMS event information is transmitted as an MBMS event information message.

As described above, the present invention proposes a method for subdividing MBMS control information and separately transmitting the subdivided MBMS control information at different times, in providing an MBMS service. As a result, the present invention proposes an RNC operation for subdividing MBMS control information and separately transmitting the subdivided MBMS control information at different times, and a UE operation for separately receiving the subdivided MBMS control information at different times, thereby receiving a desired MBMS service.

1. Transmission Procedure for an MBMS Control Message

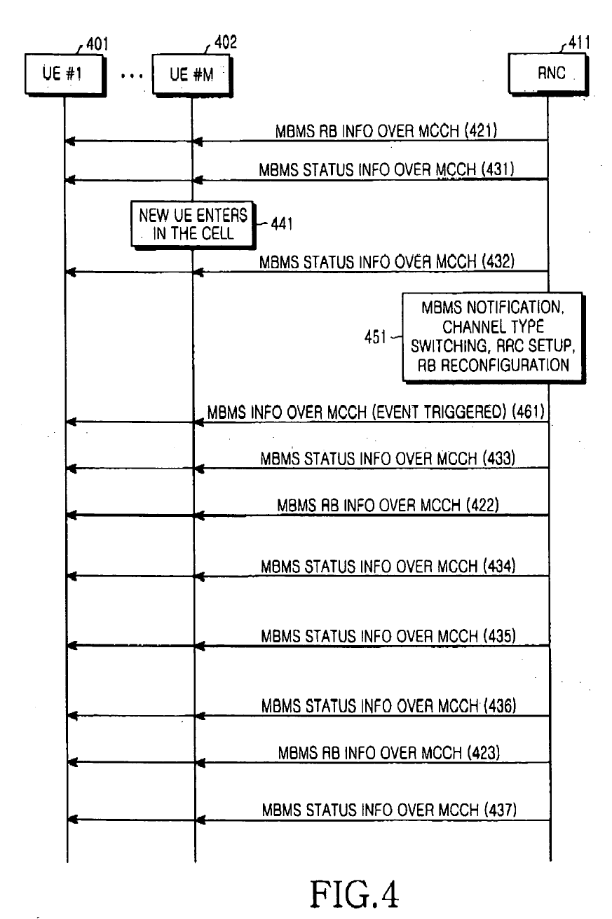

FIG. 4 is a diagram illustrating a procedure for separately transmitting subdivided MBMS control information at different times according to an embodiment of the present invention. It is assumed herein that an MBMS control message is transmitted using an MCCH, and a broadcast control channel (BCCH) transmits only MCCH information for an MBMS service but does not transmit status information or MBMS RB information of an MBMS service being serviced in a current cell. It is assumed in FIG. 4 that a UE#1 401 is a UE that is located in a particular cell and requests a particular MBMS service from an RNC 411, and a UE#M 402 is a UE that has moved from another cell to the particular cell and also requests a particular MBMS service from the RNC 411.

Referring to FIG. 4, the RNC 411 transmits MBMS RB information at a second periodic interval (Steps 421, 422, and 423), and transmits MBMS status information at a first period interval (Steps 431, 432, 433, 434, 435, 436, and 437). As can be understood from FIG. 4, the first period is relatively shorter than the second period, i.e., the MBMS status information is transmitted more frequently than the MBMS RB information. This increases probability that a UE that has moved from another cell to the current cell will receive the MBMS status information transmitted by the first period, in advance of the MBMS RB information. The MBMS status information includes an MBMS service ID for identifying MBMS services provided in the current cell and MBMS transmission mode information for selecting PtP/PtM modes.

Table 1 below shows an MBMS status information message including the MBMS status information and an MBMS RB information message including the MBMS RB information, by way of example.

TABLE 1

| Message type | MBMS control information |
|---|---|
| MBMS status information | MBMS service ID, PtP/PtM select |
| message | information |
| MBMS RB information | Logical channel, transport channel, physical |
| message | channel. |

It is noted from Table 1 that MBMS status information included in the MBMS status information message includes an MBMS service ID and PtP/PtM select information, and MBMS RB information included in the MBMS RB information message includes information on a logical channel, a transport channel, and a physical channel.

The UE#M 402 that has moved from another cell at a point indicated by reference numeral 441 receives in step 432 MBMS status information that is transmitted from the RNC 411 by the first period. The UE#M 402 detects an MBMS service ID and transmission mode select information from the received MBMS status information. The transmission mode select information detected from the MBMS status information is information used for designating one of the PtP mode and the PtM mode. Therefore, based on the MBMS status information, the UE#M 402 can determine whether its desired MBMS service is provided in the PtP mode or the PtM mode.

If it is determined that its desired MBMS service is provided in the PtP mode, the UE#M 402 receives the MBMS status information and at the same time, performs an operation for receiving the MBMS service in the Ptp mode. The operation for receiving the MBMS service in the PtP mode can be a procedure for setting up a dedicated channel. Because the MBMS status information is periodically transmitted at short intervals in the manner stated above, time delay occurring until a UE receives MBMS status information is reduced, when compared with the conventional time delay. If the MBMS status information was transmitted in the conventional method, the UE#M 402 needs a longer time delay until it acquires information indicating that the MBMS service is provided in the PtP mode.

However, if the UE#M 402 determines that its desired MBMS service is provided in the PtM mode, the UE#M 402 must receive MBMS RB information that is transmitted from the RNC 411 by the second period. In FIG. 4, the MBMS RB information is transmitted at the second periodic intervals in steps 421, 422, and 423. The UE#M 402 receives the MBMS RB information in step 422 at a time closest to the time where the MBMS status information was last received. The UE#M 402 receiving the MBMS RB information performs an operation for receiving an MBMS service in the PtM mode based on the received MBMS RB information. That is, the UE#M 402 can perform an operation for receiving an MBMS service based on the first received MBMS RB information even when a transmission mode used for its desired MBMS service is the PtM mode. This reduces a time delay required until the MBMS service is performed.

Next, a method for receiving an MBMS control message caused by occurrence of an event will be described. An MBMS event possibly occurring for an MBMS service, such as MBMS notification, Channel type switching, RB reconfiguration, and MBMS UE counting, is shown at a point denoted by reference numeral 451. If an MBMS event occurs at the point 451, the RNC 411 transmits MBMS event information for notifying UEs of the occurrence of the MBMS event in step 461. Therefore, the MBMS event information is aperiodically provided to the UEs at the time when the MBMS event occurs. This contributes to the removal of a specific time delay occurring in the conventional method of transmitting MBMS event information. Also, the MBMS event information can be repeatedly transmitted for a predetermined short term in order to allow UEs receiving the MBMS service to increase their reception rates.

The MBMS event information that is aperiodically transmitted due to occurrence of the MBMS event can have a different format according to the occurred MBMS event. This is because the RNC 411 must transmit different MBMS control information to the UE according to the occurring MBMS event. Table 2 below shows types of messages that must be transmitted according to MBMS events, and information on MBMS events corresponding to the message types.

TABLE 2

| | | MBMS event |
|---|---|---|
| MBMS event | Message type | information |
| MBMS notification | MBMS notification | MBMS service ID |
| | message | RRC connection |
| | | indicator |
| | | Pi (persistence value) |
| | | Activation time |
| MBMS counting | MBMS counting message | MBMS service ID |
| | | RRC connection |
| | | indicator |
| | | Pi (persistence value) |
| Channel type | Channel type indication | PtP/PtM select |
| notification | message | information |
| | | MBMS RB (PtM) |
| MBMS termination | MBMS termination | MBMS service ID |
| | message | |

In Table 2, an MBMS notification message is used to indicate an impending MBMS service, and includes such information as an MBMS service ID, an RRC connection indicator, a persistence value Pi, and an activation time. An MBMS counting message is a message indicating a start of a counting operation for setting a transmission mode, and includes such information as an MBMS service ID, an RRC connection indicator, and a persistence value Pi. A Channel type indication message is a message indicating channel information corresponding to a transmission mode, and includes PtP/PtM select information and MBMS RB information for the PtM mode selected. An MBMS termination message is a message indicating termination of a particular MBMS service, and includes an MBMS service ID corresponding to the MBMS service to be terminated.

As described above, the embodiment of the present invention employs both a method for periodically transmitting MBMS control information and a method for aperiodically transmitting MBMS control information due to occurrence of an event. Accordingly, it is possible to appropriately transmit MBMS control information when a UE desiring to receive an MBMS service moves, and also when an MBMS event occurs.

Finally, the RNC 411 can add a type field to an MBMS control message in order to enable a UE requesting an MBMS service to distinguish periodic and aperiodic messages. The type field includes information for distinguishing a message type. An example of the type field is shown in Table 3 below.

TABLE 3

| Message type | |
|---|---|
| (ENUM) | MBMS control information |
| 0 | MBMS notification message (MBMS event information |
| | message) |
| 1 | MBMS counting message (MBMS event information |
| | message) |
| 2 | Channel type indication message (MBMS event |
| | information message) |
| 3 | MBMS termination message (MBMS event information |
| | message) |
| 4 | MBMS status information message |
| 5 | MBMS RB message |

As shown in Table 3, ‘0’ indicates an MBMS notification message caused by occurrence of an event, ‘1’ indicates an MBMS counting message caused by occurrence of an event, ‘2’ indicates a Channel type indication message caused by occurrence of an event, ‘3’ indicates an MBMS termination message caused by occurrence of an event, ‘4’ indicates an MBMS status information transmitted at the second periodic interval, and ‘5’ indicates an MBMS RB message transmitted at the first periodic interval.

As described above, the present invention preferentially provides MBMS status information to a UE that has moved from another cell, and thereafter, provides MBMS RB information to the UE, thereby minimizing a time delay occurring until the UE receives a desired MBMS service. As a result, the present invention efficiently provides an MBMS service while correcting mobility of a new UE entering the current cell.

2. Operation of an RNC

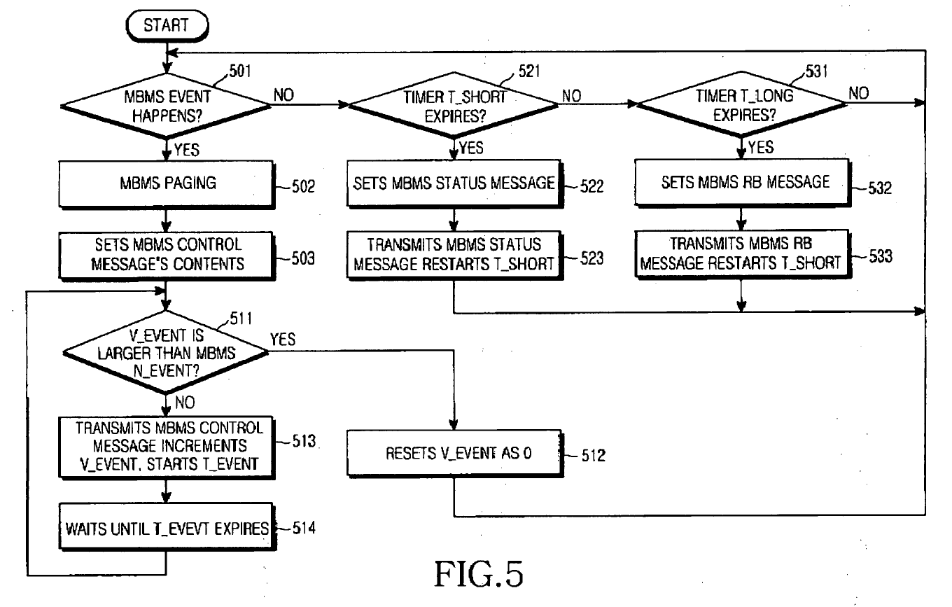

FIG. 5 is a flowchart illustrating an operation of an RNC according to an embodiment of the present invention. More specifically, FIG. 5 illustrates a procedure for transmitting by an RNC an MBMS control message over MCCH in the method described in conjunction with FIG. 4.

Referring to FIG. 5, in step 501, an RNC determines whether an MBMS event has occurred. The MBMS event includes MBMS notification, MBMS counting, Channel type notification, and MBMS termination. If it is determined that the MBMS event has occurred, in step 502, the RNC transmits an MBMS paging message including an MBMS event indicator for distinguishing the occurred MBMS event, to UEs located in a particular cell. The MBMS paging message is defined as a message indicating an occurrence of the MBMS event. The integers indicating the message types in Table 3 can be used as the MBMS event indicator. For example, when an event requesting MBMS termination occurs, the MBMS event indicator becomes ‘3’, and the MBMS paging information includes ‘3’ as the MBMS event indicator.

After transmitting the MBMS paging message, in step 503, the RNC generates an MBMS event information message according to an MBMS control message type corresponding to the occurred MBMS event. In step 511, the RNC determines whether the generated MBMS event information message has been transmitted as many times as a maximum transmission count. The determination can be achieved by comparing a repeated transmission count V_event of the MBMS event information message with a maximum value N_event of the set V_event. If V_event is larger than N_event, the RNC determines that the MBMS event information message has been repeatedly transmitted as many times as it desires. The parameters V_event and N_event newly defined in the present invention are provided to increase probability that a UE will receive an MBMS control message caused by occurrence of the MBMS event, and are used to repeatedly transmit the MBMS control message for a predetermined short time. The V_event indicates a transmission count of the MBMS control message transmitted by the RNC, and the N_event indicates a possible maximum value of the V_event.

If it is determined that the MBMS event information message has not been repeatedly transmitted as many times as it desires, the RNC proceeds to step 513. However, if it is determined that the MBMS event information message has been repeatedly transmitted as many times as it desires, the RNC proceeds to step 512.

In step 513, the RNC transmits the MBMS event information message, increases the V_event by one, and then activates a timer T_event. The timer T_event is a timer value newly defined so that the MBMS event information message can be repeatedly transmitted at a predetermined periodic interval. In step 514, the RNC waits until the timer T_event expires. When the T_event expires, the RNC returns to step 511. The steps 511, 513, and 514 are repeatedly performed until the MBMS event information message is transmitted as many times as a desired transmission count N_event. In step 512, the RNC sets the V_event to ‘0’ and ends transmission of the MBMS control message corresponding to the occurred MBMS event.

In step 521, the RNC determines whether it is time to transmit an MBMS status information message that is transmitted at the first periodic interval. Accordingly, a timer T_short for checking the first period is newly defined in the present invention. The timer T_short is a value indicating a transmission interval of the MBMS status message. If it is determined in step 521 that the timer T_short has expired, in step 522, the RNC generates an MBMS status information message. In step 523, the RNC transmits the generated MBMS status information message and then, restarts the timer T_short. Through the steps 521, 522 and 523, the RNC can transmit the MBMS status information message at the first periodic interval.

In step 531, the RNC determines whether it is time to transmit an MBMS RB information message that is transmitted at the second periodic interval. The second periodic interval is longer than the first periodic interval. A timer T_long for checking the second period is newly defined in the present invention. The T_long is a value indicating a transmission interval of the MBMS RB information message. If it is determined in step 531 that the timer T_long has expired, in step 532, the RNC generates the MBMS RB information message. In step 533, the RNC transmits the generated MBMS RB information message and then, restarts the timer T_long. Through the steps 531, 532 and 533, the RNC can transmit the MBMS RB information message at the second periodic interval.

Table 4 below shows the parameters newly defined in FIG. 5.

TABLE 4

| Timer/Variable/ | |
|---|---|
| Constant | Function |
| T_short | It indicates a transmission interval of an MBMS |
| | status information message that is periodically |
| | transmitted. |
| T_long | It indicates a transmission interval of an MBMS RB |
| | information message that is periodically transmitted. |
| T_event | It indicates a transmission interval of a consecutive |
| | MBMS control message when the corresponding |
| | MBMS control message is repeatedly transmitted |
| | due to occurrence of an MBMS event. |
| V_event | It indicates a transmission count of an MBMS |
| | control message that is repeatedly transmitted when |
| | an MBMS event occurs. |
| N_event | It indicates a maximum value of V_event. |

3. Operation of a UE

A UE operation according to an embodiment of the present invention is divided into a UE operation of receiving an MBMS service and a UE operation of performing cell reselection. The UE operation of receiving an MBMS service can be caused by an MBMS event information message provided from an RNC. The UE operation of performing cell reselection can be caused by an MBMS status information message or an MBMS RB information message provided from the RNC.

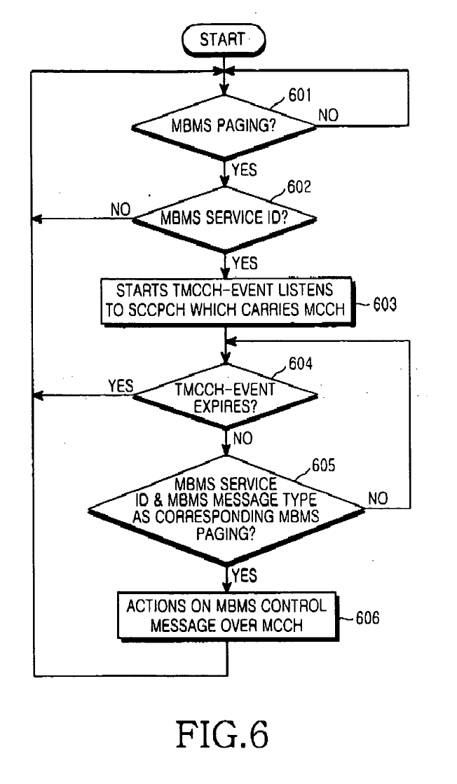

FIG. 6 is a flowchart illustrating a procedure performed by a UE receiving an MBMS service according to an embodiment of the present invention. Referring to FIG. 6, in step 601, a UE checks whether MBMS paging is received from an RNC. The MBMS paging is used in order that the RNC may inform a UE receiving a particular MBMS service of an MBMS event occurring for the particular MBMS service. The MBMS paging method is changeable according to a mode and a state of the UE.

In FIG. 6, a paging method for a UE in a CELL_FACH state of a connected mode and a 3-step paging method for a UE in an IDLE mode, a CELL_PCH state, or a URA_PCH state, are used. A UE in a CELL_DCH state can transmit and receive an MBMS control message over DCCH. The 3-step paging method refers to a method in which a UE analyzes an MBMS paging indicator in a PICH frame to detect a paging message of corresponding PCH, analyzes an MBMS service ID for an MBMS service the UE has joined, and then receives MBMS control information over MCCH. If a 2-step paging method in which a paging message exchanged over PCH is transmitted over MCCH is used, reception of the MBMS paging message in step 601 is achieved not through PCH but through MCCH. Therefore, reception of the MCCH in step 603 will be performed before step 601.

If the MBMS paging is received, in step 602, the UE analyzes an MBMS service ID for distinguishing an MBMS service corresponding to the MBMS paging. If the analyzed MBMS service ID does not indicate an MBMS service the UE is currently receiving, the UE disregards the received MBMS paging. However, if the analyzed MBMS service ID is identical to an MBMS service ID for the MBMS service the UE is currently receiving, the UE proceed to step 603.

In step 603, the UE activates a newly defined timer T_mcch-event and waits to receive a secondary common control physical channel (S-CCPCH) to which MCCH is mapped. In the present invention, it is assumed that an MCCH is mapped to one S-CCPCH before being transmitted. However, the present invention can be implemented in the same way even though the MCCH is mapped to all S-CCPCHs before being transmitted. The T_mcch-event is used to restrict a time from a point where the UE receives the MBMS paging to a point where the UE receives an MBMS event information message corresponding to the MBMS event. By restricting the time in this way, it prevents the UE from unnecessarily analyzing MCCH in order to receive the MBMS event information message corresponding to the MBMS paging.

In step 604, the UE determines whether the T_mcch-event has expired. If the UE fails to receive an MBMS event information message until the T_mcch-event expires, the UE stops reception of the MCCH. However, if it is determined that the T_mcch-event has not expired, the UE continues to analyze MCCH in step 605 to receive a desired MBMS event information message.

If the UE receives a desired MBMS event information message before the T_mcch-event expires, in step 606, the UE analyzes a type field in the received MBMS event information message and performs an operation corresponding to the analyzed type field. For example, it is assumed that a UE in an IDLE mode, receiving a particular MBMS service, has received MBMS paging having an MBMS event #1 (MBMS counting) for the particular MBMS service. The UE in the IDLE mode continuously receives MCCH for the T_mcch-event in order to receive an MBMS event information message having an MBMS service ID for the MBMS paging. If the MBMS event information message having an MBMS service ID is received, the UE determines whether a type field in the MBMS event information message is set to ‘1’. If the type field is set to ‘1’, the UE further determines whether an RRC connection indicator is set to ‘True’. If the RRC connection indicator is set to ‘True’, the UE performs an operation of setting up RRC connection.

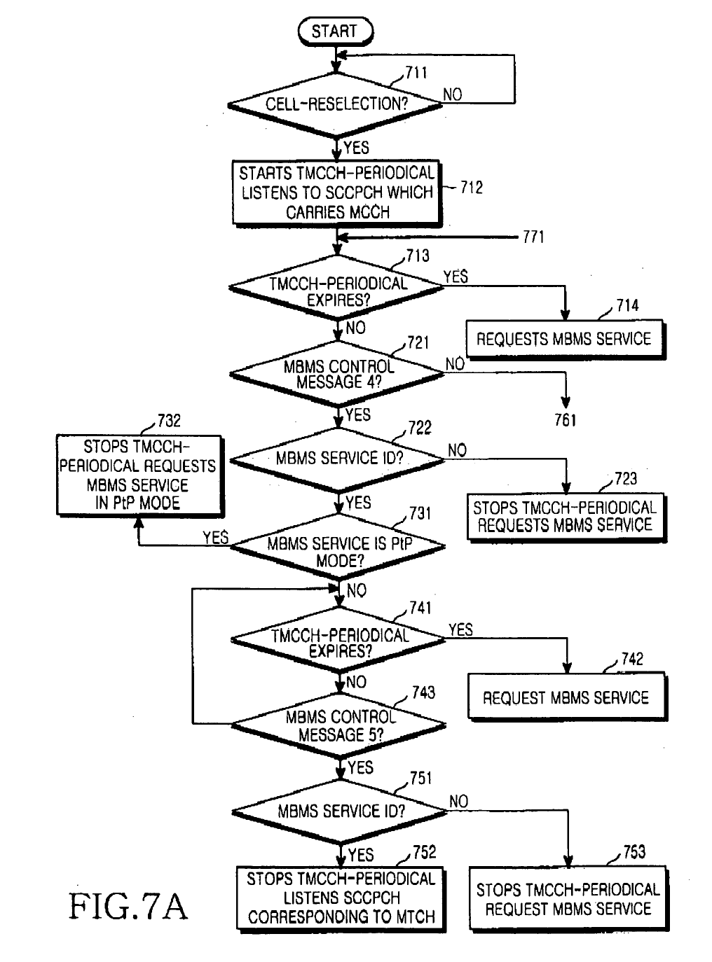

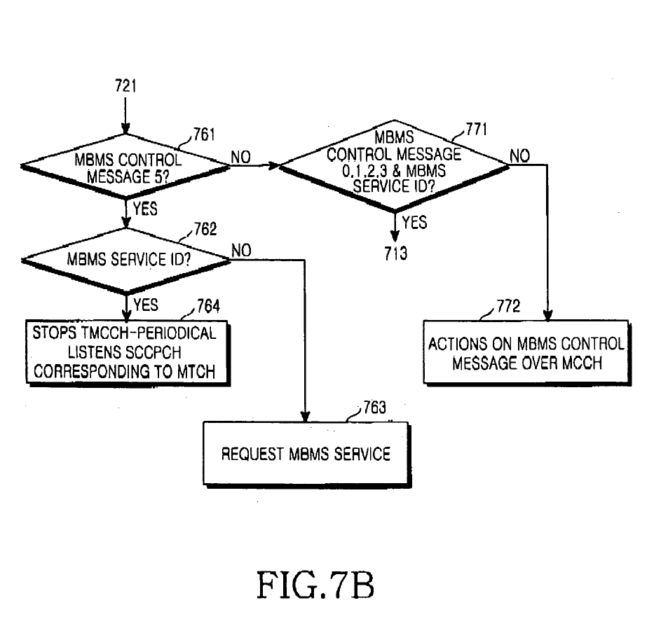

FIGS. 7A and 7B are flowcharts illustrating a cell reselection procedure performed by a UE according to an embodiment of the present invention. Referring to FIGS. 7A and 7B, in step 711, a UE determines whether cell reselection has been performed. If It is determined in step 711 that a cell is reselected due to movement of the UE, in step 712, the UE activates a newly defined timer T_mcch-periodical, and receives S-CCPCH to which MCCH is mapped. The UE has information on the MCCH before cell reselection is performed as it receives the MCCH information over BCCH. This is because it is assumed that MCCH information is transmitted over BCCH. The T_mcch-periodical is used to restrict a time for which an MBMS control message periodically transmitted to support mobility of the UE should be received. By restricting the time in this way, it prevents the UE from unnecessarily analyzing an MCCH in order to receive the periodically transmitted MBMS control message. Accordingly, in step 713, the UE monitors whether the T_mcch-periodical expires.

If the UE fails to receive the periodically transmitted MBMS control message corresponding to a desired MBMS service until the T_mcch-periodical expires, the UE proceeds to step 714, determining that transmission of the MBMS control message over the MCCH is failed. In step 714, the UE sends a request for the desired MBMS service to an RNC. However, if the UE receives the periodically transmitted MBMS control message corresponding to the desired MBMS service before the T_mcch-periodical expires, in step 721, the UE determines whether a type field in the MBMS control message is set to ‘4’. If the type field is set to ‘4’, in step 722, the UE determines whether an MBMS service ID in the received MBMS control message is identical to an MBMS service ID for its desired MBMS service. An MBMS control message with a type field being set to ‘4’ corresponds to an MBMS status information message. The MBMS status information message includes an MBMS service ID and transmission mode select information for selecting the PtP/PtM modes.

If it is determined that an MBMS service ID for the desired MBMS service is not included in the MBMS status information message and an MBMS notification has been received, the UE proceeds to step 723, determining that the desired MBMS service is not provided in the new cell to which it has moved. In step 723, the UE stops T_mcch-periodical and requests the RNC to provide its desired MBMS service.

However, if an MBMS service ID for its desired MBMS service is included in the MBMS status information message, the UE proceeds to step 731. In step 731, the UE analyzes transmission mode select information included in the MBMS status information message to determine whether the desired MBMS service is provided in the PtP mode or the PtM mode. If it is determined that the MBMS service is serviced in the PtP mode, the UE the UE proceeds to step 732, where it stops the T_mcch-periodical and performs an operation for receiving the MBMS service in the PtP mode.

However, if it is determined that the MBMS service is serviced in the PtM mode, in steps 741 and 743, the UE monitors whether an MBMS RB information message transmitted at the second periodic interval from the RNC is received before the T_mcch-periodical expires. Whether an MBMS control message received over MCCH is an MBMS RB information message can be determined by checking a type field included therein. Determining whether the T_mcch-periodical has expired, prevents the UE from unnecessarily analyzing MCCH in order to receive the MBMS RB information message. If an MBMS control message with a type field being set to ‘5’ has been received before the T_mcch-periodical expires, the UE determines that the MBMS RB information message has been received. The MBMS RB information message includes information on an MBMS traffic channel (MTCH).

If the UE fails to receive the MBMS RB information message before the T_mcch-periodical expires, the UE proceeds to step 742, where it requests the RNC to provide the desired MBMS service. However, when the UE has received the MBMS RB information message before the T_mcch-periodical expires, the UE proceeds to step 751, where it determines whether the received MBMS RB information message includes an MBMS service ID of its desired MBMS service. If it is determined that the received MBMS RB information message does not include an MBMS service ID of its desired MBMS service, the UE proceeds to step 753, determining that transmission of the MBMS control message over the MCCH is failed. In step 753, the UE stops the T_mcch-periodical and requests the RNC to provide the desired MBMS service.

However, if an MBMS service ID and RB information for its desired MBMS service are included in the received MBMS RB information message, the UE proceeds to step 752. In step 752, the UE stops the T_mcch-periodical and receives S-CCPCH to which MTCH is mapped, based on the RB information, thereby receiving MBMS data.

If it is determined in step 721 that the type field is not set to ‘4’, the UE proceeds to step 761, in FIG. 7B, where it determines whether the type field is set to ‘5’. If the type field is set to ‘5’, the UE proceeds to step 762. When the type field is set to ‘5’, the received MBMS control message does not correspond to an MBMS status information message but to an MBMS RB information message.

In step 762, the UE determines whether an MBMS service ID in the MBMS RB information message is identical to an MBMS service ID for its desired MBMS service. If the MBMS service IDs are identical to each other, the UE proceeds to step 764, where it stops the T_mcch-periodical and receives S-CCPCH to which MTCH is mapped, based on the RB information included in the MBMS RB information message. As a result, the UE can receive the MBMS data.

However, when the MBMS service IDs are not identical to each other, the UE proceeds to step 763, where it requests the RNC to provide its desired MBMS service.

If it is determined in step 771 that the received MBMS control message corresponds to an MBMS event information message caused by occurrence of an MBMS event and includes an MBMS service ID for the desired MBMS service, the UE proceeds to step 772. However, if the received MBMS control message corresponds to an MBMS event information message caused by occurrence of an MBMS event and does not include an MBMS service ID for the desired MBMS service, the UE proceeds to step 713 in FIG. 7A. The MBMS event information message corresponds to an MBMS control message in which a type field is set to one of ‘0’, ‘1’, ‘2’, and ‘3’.

In step 772, the UE performs an operation corresponding to the type of the MBMS event information message. Otherwise, if the type field is set to none of ‘0’, ‘1’, ‘2‘and ’3’, or the received MBMS control message does not include an MBMS service ID for the desired MBMS service, the UE returns to step 713 to receive the next MBMS status information message before expiration of the T_mcch-periodical and to determine whether the desired MBMS service is provided in the PtP mode or whether the desired MBMS service is not provided.

Table 5 below shows definitions of the parameters used in a UE according to an embodiment of the present invention.

TABLE 5

| Timer | Function |
|---|---|
| T_mcch-event | It indicates a maximum time for which a UE can |
| | receive a corresponding MBMS control message |
| | after it receives an MBMS paging message caused |
| | by occurrence of an MBMS event. |
| T_mcch-periodical | It indicates a maximum time for which a UE can |
| | receive MBMS control information of a |
| | new cell after cell reselection is performed due to |
| | movement of the UE to the new cell. |

As is understood from the foregoing description, a mobile communication system supporting an MBMS service transmits MBMS status information using a short period and MBMS RB information using a relatively longer period, in periodically transmitting MBMS control information, thereby efficiently supporting mobility of a UE. As a result, a UE that has moved to a new cell can rapidly receive information on an MBMS service state in the new cell, and the UE can reduce a time delay in performing an operation for receiving an MBMS service in the new cell, thereby securing continuity of the MBMS service.

In addition, when an MBMS event for the MBMS service occurs, MBMS control information necessary for the MBMS event is aperiodically transmitted, thereby reducing a time delay in receiving an MBMS service by the UE and preventing a possible misoperation.

While the present invention has been shown and described with reference to certain preferred embodiments thereof, it will be understood by those skilled in the art that various changes in form and details may be made therein without departing from the spirit and scope of the present invention as defined by the appended claims.

1. A method for transmitting a control message for a Multimedia Broadcast/Multicast Service (MBMS) from a radio network controller (RNC) to each cell in a mobile communication system including the RNC, a plurality of Node Bs, each of the Node Bs being connected to the RNC and controlling at least one cell, and a plurality of user equipments (UEs) located in each cell, the method comprising the steps of:
transmitting a first control message for the MBMS service at a predetermined periodic interval; and
transmitting a second control message caused by an occurrence of an event being involved in control on the MBMS service, at the occurrence of the event.

2. The method of claim 1, wherein the first message is divided into a status information message transmitted at a first periodic interval and a radio bearer (RB) information message transmitted at a second periodic interval, which is longer than the first periodic interval.

3. The method of claim 2, wherein the status information message includes an MBMS service identifier and transmission mode select information.

4. The method of claim 3, wherein the transmission mode select information is information used to select one of a point-to-point mode and a point-to-multipoint mode.

5. The method of claim 2, wherein the RB information message includes information for establishing a radio channel for providing the MBMS service.

6. The method of claim 1, wherein the second control message is one of an MBMS notification message, an MBMS counting message, a channel type indication message, and an MBMS termination message.

7. The method of claim 1, wherein the first control message and the second control message each include information for distinguishing a message type.

8. A method for transmitting a control message for a Multimedia Broadcast/Multicast Service (MBMS) from a radio network controller (RNC) to each cell in a mobile communication system including the RNC, a plurality of Node Bs, each of the Node Bs being connected to the RNC and controlling at least one cell, and a plurality of user equipments (UEs) located in each cell, the method comprising the steps of:
transmitting a status information message that a UE preferentially receives in order to receive the MBMS service among control messages for the MBMS service, at a first periodic interval; and
transmitting a radio bearer (RB) information message among the control messages for the MBMS service at a second periodic interval, which is longer than the first periodic interval.

9. The method of claim 8, wherein the status information message includes an MBMS service identifier and transmission mode select information.

10. The method of claim 9, wherein the transmission mode select information is information used to select one of a point-to-point mode and a point-to-multipoint mode.

11. The method of claim 8, wherein the RB information message includes information for establishing a radio channel for providing the MBMS service.

12. The method of claim 8, further comprising the step of transmitting a control message for an irregularly occurring event, if the irregularly occurring event being involved in control of the MBMS service occurs.

13. The method of claim 12, wherein the control message caused by the occurrence of the irregularly occurring event is one of an MBMS notification message, an MBMS counting message, a channel type indication message, and an MBMS termination message.

14. The method of claim 12, wherein the control message include information for distinguishing a message type.

15. A method for receiving by a user equipment (UE) a control message for a Multimedia Broadcast/Multicast Service (MBMS) from a radio network controller (RNC) in a mobile communication system including the RNC, a plurality of Node Bs, each of the Node Bs being connected to the RNC and controlling at least one cell, and a plurality of user equipments (UEs) located in each cell, the method comprising the steps of:
receiving a first control message for the MBMS service that is transmitted by a predetermined periodic interval; and
receiving a second control message that is aperiodically transmitted at an occurrence of an event being involved in control of the MBMS service.

16. The method of claim 15, wherein the first control message is divided into a status information message transmitted at a first periodic interval and a radio bearer (RB) information message transmitted at a second periodic interval, which is longer than the first periodic interval.

17. The method of claim 16, wherein the status information message includes an MBMS service identifier and transmission mode select information.

18. The method of claim 17, wherein the transmission mode select information is information used to select one of a point-to-point mode and a point-to-multipoint mode.

19. The method of claim 16, wherein the RB information message includes information for establish a radio channel for providing the MBMS service.

20. The method of claim 15, wherein the second control message is one of an MBMS notification message, an MBMS counting message, a channel type indication message, and an MBMS termination message.

21. The method of claim 15, wherein the first control message and the second control message each include information for distinguishing a message type.

22. A method for receiving by a user equipment (UE) a control message for a Multimedia Broadcast/Multicast Service (MBMS) from a radio network controller (RNC) in a mobile communication system including the RNC, a plurality of Node Bs, each of the Node Bs being connected to the RNC and controlling at least one cell, and a plurality of user equipments (UEs) located in each cell, the method comprising the steps of:
receiving a status information message that a UE preferentially receives in order to receive the MBMS service among control messages for the MBMS service, at a first periodic interval; and
receiving a radio bearer (RB) information message among the control messages for the MBMS service, at a second periodic interval, which is longer than the first periodic interval.

23. The method of claim 22, wherein the status information message includes an MBMS service identifier and transmission mode select information.

24. The method of claim 23, wherein the transmission mode select information is information used to select one of a point-to-point mode and a point-to-multipoint mode.

25. The method of claim 22, wherein the RB information message includes information for establishing a radio channel for providing the MBMS service.

26. The method of claim 22, further comprising the step of receiving an event-related control message that is aperiodically transmitted at an irregular occurrence of an event being involved in control of the MBMS service.

27. The method of claim 26, wherein the event-related control message is one of an MBMS notification message, an MBMS counting message, a channel type indication message, and an MBMS termination message.

28. The method of claim 26, wherein the control message transmitted from the RNC includes information for distinguishing a message type.

29. A method for transmitting a control message for a Multimedia Broadcast/Multicast Service (MBMS) from a radio network controller (RNC) in a mobile communication system including the RNC, a plurality of Node Bs, each of the Node Bs being connected to the RNC and controlling at least one cell, and a plurality of user equipments (UEs) located in each cell, the method comprising the steps of:
transmitting a first control message for the MBMS service at a predetermined periodic interval; and
generating a second control message caused by an event being involved in control of the MBMS service, and repeatedly transmitting the second control message at a start point of a transmission period for which the first control message is transmitted.

30. The method of claim 29, wherein the second control message is one of an MBMS notification message, an MBMS counting message, a channel type indication message, and an MBMS termination message.

31. The method of claim 29, wherein the first control message and second control message each include information for distinguishing a message type.
